(19) United States
(12) Patent Application Publication
(10) Pub. No.: US 2013/0048930 A1
(43) Pub. Date: Feb. 28, 2013

(54) RIVETED STRUCTURE FOR A PULLEY SEAT

(71) Applicant: Wan-Lai Liau, Taipei City (TW)

(72) Inventor: Wan-Lai Liau, Taipei City (TW)

(21) Appl. No.: 13/223,216

(22) Filed: Aug. 31, 2011

(51) Int. Cl. B66D 3/04

(52) U.S. Cl. 254/390

(57) ABSTRACT

An improved riveted structure for a pulley seat is provided. The riveted structure essentially includes a panel and a base. The bottom surface of the panel is bilaterally provided with hot-forged rivets, and the base is bilaterally provided with through holes corresponding in position to the rivets. The riveted structure is characterized in that the through holes of the base are elliptical to facilitate insertion of the rivets. In addition, a washer is mounted around each rivet before the rivets are stamped. Thus, once the rivets are stamped to connect the panel to the base, the stamped rivets leave no traces on the surface of the panel. Also, production efficiency and the riveting effect can both be increased.

### BACKGROUND OF THE INVENTION

1. Technical Field

The present invention relates to the structure of a pulley seat and, more particularly, to an improved structure for a pulley seat, wherein rivet connection between the panel and the base of the riveted structure leaves no traces of such connection on the upper surface of the panel and wherein the riveted structure can be efficiently produced and has strong rivet connection between the panel and the base.

2. Description of Related Art

Pulley devices—which feature structural simplicity, easy operation, long service lives, and wide applicability—have long been used in many different industries and are still in extensive use today.

Pulley devices are available in various configurations. The inverted square U-shaped pulley seat, for example, is mainly used in aluminum doors and windows, sliding doors, and other objects designed to move along fixed tracks. Typically, an inverted square U-shaped pulley seat is composed of a base 1 and a panel 20 connected together by rivets or screws, and the base 1 is provided with a pulley 12.

Conventionally, the connection between the base 1 and the panel 20 of an inverted square U-shaped pulley seat is carried out by rivet installation or screw engagement, wherein rivets or screws are inserted into and fastened between corresponding through holes formed on two sides of the base 1 and of the panel 20. As a result, the panel 20 is often left with unsightly and irremovable traces of the rivet heads or screw heads. To eliminate such traces, the inventor of the present invention came up with a solution, for which a patent application was filed with the US Patent and Trademark Office and for which the inventor was granted U.S. Pat. No. 6,478,286.

According to the afore-cited US patent, an inverted square U-shaped pulley seat free of traces of rivet or screw connection is achieved mainly by the following means. The pulley seat has a base 10 and a panel 20. The bottom surface of the panel 20 is hot-forged with downwardly extending rivets 30 on two sides. The rivets 30 are inserted into the corresponding through holes of the base 10 respectively and are stamped so that the panel 20 and the base 10 are riveted together.

In the manufacturing process of the patented inverted square U-shaped pulley seat described above, the panel 20 is released from the molds after the two rivets 30 are hot-forged on the two sides of the bottom surface of the panel 20. However, the rivets 30 are subject to deformation while the panel 20 is removed from the molds. Should the rivets 30 be deformed, the center-to-center distance between the two rivets 30 extending from the panel 20 may deviate from the design value, making it difficult to insert the rivets 30 precisely into the through holes during preliminary assembly of the panel 20 and the base 10. While this problem seems solvable by tapering the tail ends of the rivets 30, it is practically unfeasible to provide each rivet 30 with a chamfered or tapered tail end, for such ends will not expand sufficiently when stamped but provide a compromised riveting effect, if any.

Therefore, the primary object of the present invention is to provide an improved riveted structure for a pulley seat, wherein a special structure is employed not only to prevent the riveting of the panel and the base of the pulley seat from leaving traces of rivet or screw connection on the upper surface of the panel, but also to increase production efficiency and the riveting effect.

### BRIEF SUMMARY OF THE INVENTION

To achieve the above object, the present invention provides a riveted structure for a pulley seat, wherein the riveted structure essentially includes a panel whose bottom surface is bilaterally provided with hot-forged rivets, and a base bilaterally provided with through holes corresponding in position to the rivets. The panel and the base are connected to each other by a specific means to provide both an esthetically pleasing appearance and strong rivet connection.

The technical features of the present invention are as follows. The through holes of the base have an elliptical configuration to facilitate insertion of the rivets, and a washer is mounted around each rivet before the rivets are stamped. Thus, even if the rivets 30 on the panel 2 are slightly deformed and have their center-to-center distance altered, the rivets 30 are still allowed to extend into the through holes 14 of the base 10 respectively so that not only can the panel 20 and the base 10 be smoothly assembled and stamped, but also the surface of the panel is prevented from showing traces of the rivets. Besides, production efficiency can be enhanced, and the riveting effect increased.

### BRIEF DESCRIPTION OF THE SEVERAL VIEWS OF THE DRAWINGS

The structure as well as a preferred mode of use, further objects, and advantages of the present invention will be best understood by referring to the following detailed description of an illustrative embodiment in conjunction with the accompanying drawings, in which:

FIG. 1 is a perspective view of an embodiment of the present invention;

FIG. 2 is an exploded perspective view of the embodiment depicted in FIG. 1, showing in particular a panel and a base;

FIG. 3 is a sectional view of the embodiment depicted in FIG. 1, with the panel detached from the base;

FIG. 4 is another sectional view of the embodiment depicted in FIG. 1, with the panel riveted to the base;

FIG. 5 is a front view and a top view of the base according to the embodiment depicted in FIG. 1; and

FIG. 6 is a partial enlarged view of FIG. 4.

### DETAILED DESCRIPTION OF THE INVENTION

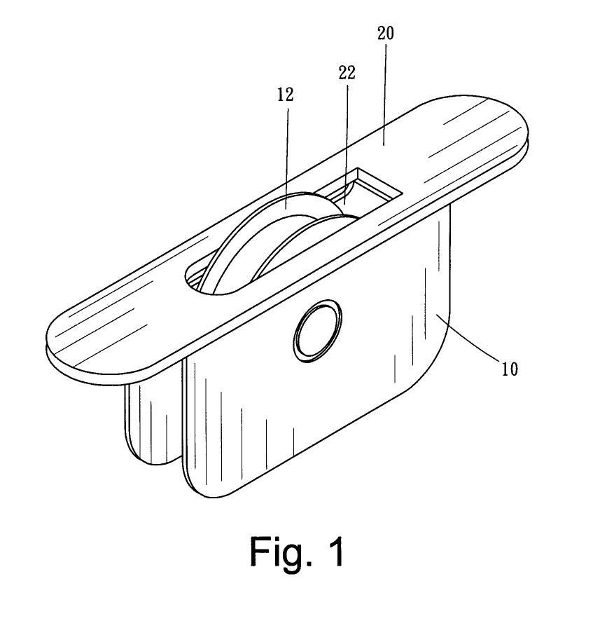

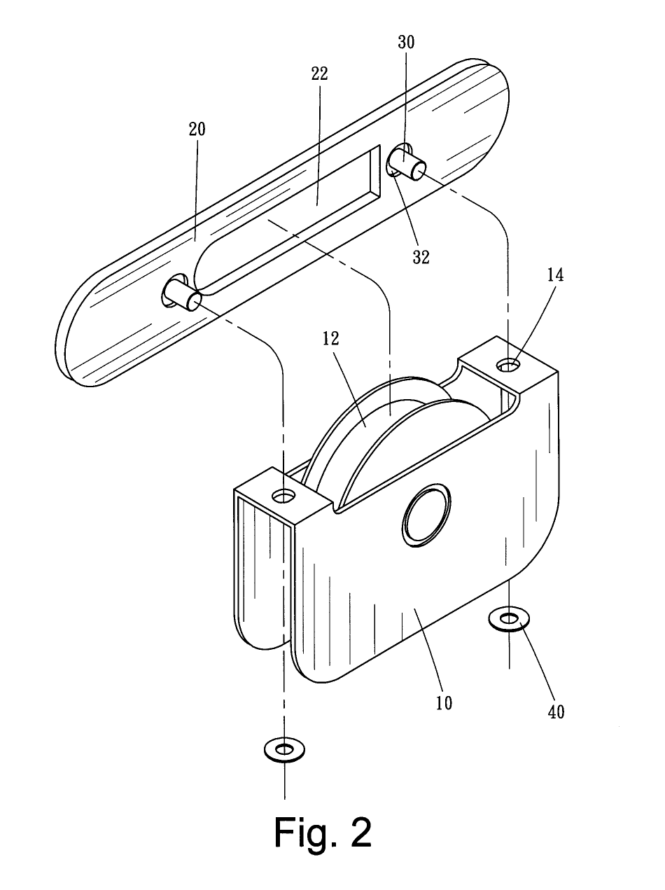

Referring to FIGS. 1 and 2, a riveted structure for a pulley seat according to an embodiment of the present invention essentially includes a base 10, a panel 20, and a set of washers 40.

The base 10 is pivotally provided with a pulley 12 and has an upper surface bilaterally and symmetrically provided with elliptical through holes 14. Each of the elliptical through holes 14 has a transverse diameter A extending generally along the longitudinal direction of the base 10 and a conjugate diameter B extending generally along the transverse direction of the base 10, wherein the transverse diameter A is longer than the conjugate diameter B.

The panel 20 has a slot 22 corresponding in position to the pulley 12. The bottom surface of the panel 20 is bilaterally and integrally formed with downwardly extending rivets 30. Each rivet 30 has a base portion connected to the panel 20 and surrounded by an annular recess 32. Thus, when the rivets 30 are stamped, a portion of the material of the deformed rivets 30 is filled in the annular recesses 32 to further strengthen the rivet connection between the panel 20 and the base 10.

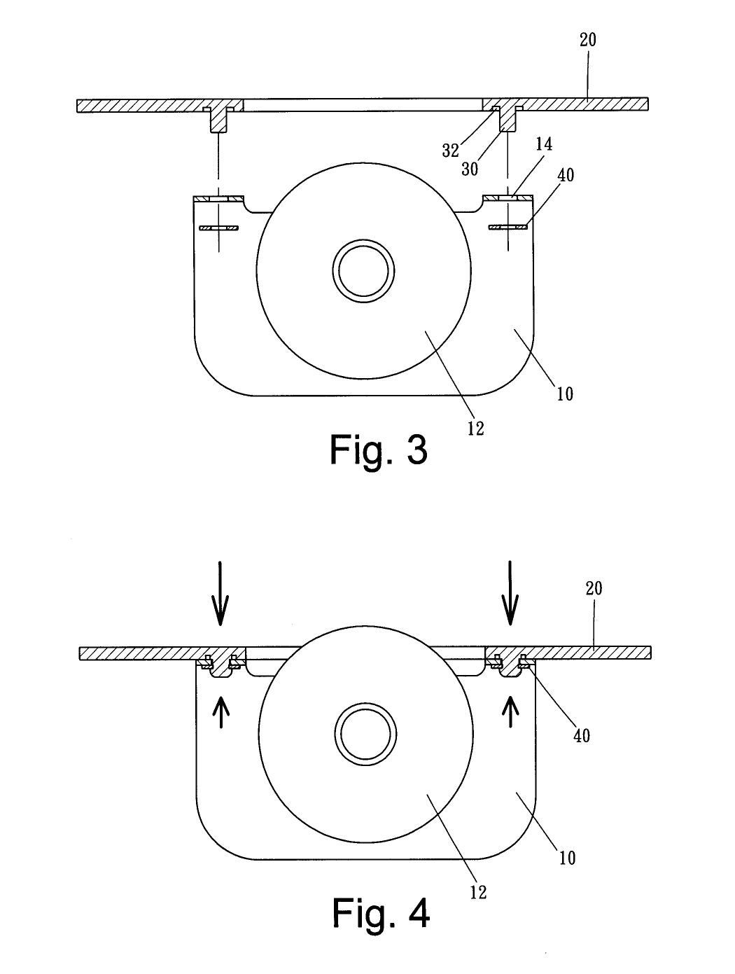

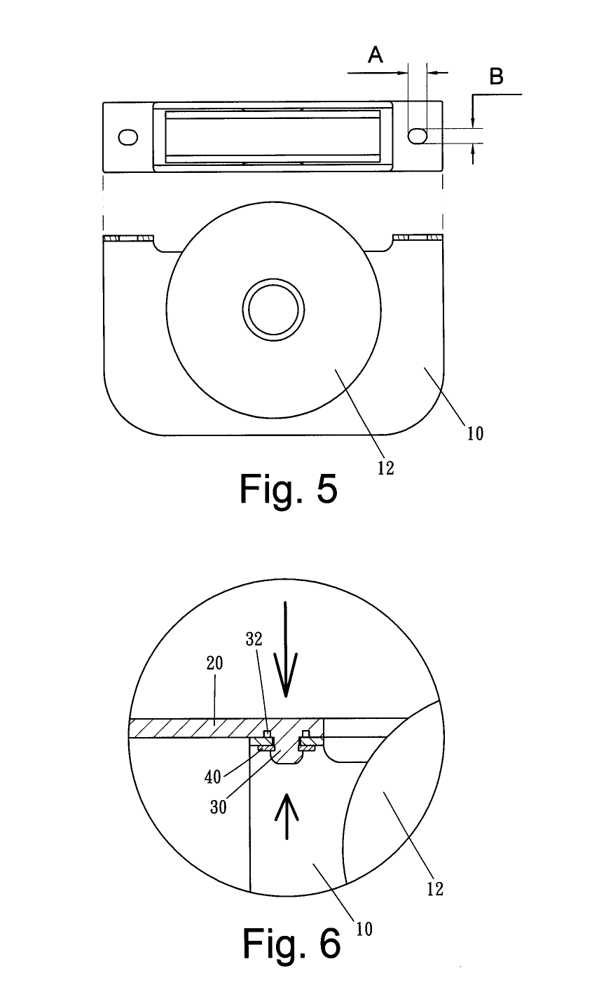

Reference is now made to FIGS. 3 to 6. The rivets 30 are inserted into the corresponding elliptical through holes 14 of the base 10 and mounted with the washers 40 respectively. Then, the rivets 30 are deformed by stamping so as to be connected to the rims of the corresponding elliptical through holes 14. As a result, the panel 20 and the base 10 are assembled and riveted to each other.

As the base 10 must be stamped to acquire the inverted square U shape, it is seldom made of a hard material. Therefore, if the tail ends of the rivets 30 are directly pressed against the rims of the through holes of the base 10 when deformed upon stamping, the portions of the base 10 that are adjacent to the through holes are very likely to be damaged, and the riveting effect thus produced is weak. In view of this, the washers 40 in the present embodiment are made of a harder material than the panel 20, and the tail ends of the rivets 30, once stamped and deformed, are directly pressed against the relatively hard washers 40 to produce a better riveting effect.

According to the structure described above, the rivets 30 can be easily inserted into the elliptical through holes 14 and will leave no traces of rivet connection on the surface of the panel 20. Also, the washers 40 help increase the riveting effect of the rivets 30 on the panel 20 and the base 10.

What is claimed is:

1. A riveted structure for a pulley seat, comprising:
a base (10) pivotally provided with a pulley (12) and having an upper surface bilaterally and symmetrically formed with elliptical through holes (14);
a panel (20) formed with a slot (22) corresponding in position to the pulley (12), the panel (20) having a bottom surface bilaterally and integrally formed with downwardly extending rivets (30), wherein each said rivet (30) has a base portion connected to the panel (20) and surrounded by an annular recess (32) so that when the rivets (30) are stamped and deformed, a portion of a material of the rivets (30) is filled in the annular recesses (32); and
a set of washers (40);
wherein the rivets (30) of the panel (20) are respectively inserted into the elliptical through holes (14) of the base (10) and, after the washers (40) are mounted around tail ends of the rivets (30) respectively, the rivets (30) are stamped and deformed so as to be connected to rims of the elliptical through holes (14) respectively, thereby riveting the panel (20) and the base (10) together.

2. The riveted structure of claim 1, wherein the washers (40) are made of a harder material than the panel (20), and the tail ends of the rivets (30) are directly pressed against the relatively hard washers (40) when deformed upon stamping, thereby producing an enhanced riveting effect.

3. The riveted structure of claim 1, wherein each said elliptical through hole (14) has a transverse diameter extending generally along a longitudinal direction of the base (10) and a conjugate diameter extending generally along a transverse direction of the base (10), the transverse diameter being longer than the conjugate diameter.
